(19) United States
(12) Patent Application Publication
(10) Pub. No.: US 2017/0058564 A1
(43) Pub. Date: Mar. 2, 2017

(54) AUTOMATIC LOCKING MECHANISM

(71) Applicant: Hao MIN, Nanjing, Jiangsu (CN)

(72) Inventors: Hao MIN, Nanjing, Jiangsu (CN); Kaojin QIAN, Nanjing, Jiangsu (CN)

(21) Appl. No.: 15/307,908

(22) PCT Filed: Nov. 12, 2014
(86) PCT No.: PCT/CN2014/090930

§ 371 Date: Oct. 31, 2016

(30) Foreign Application Priority Data
Apr. 29, 2014 (CN) 201410175814.9

(51) Int. Cl. E05B 17/20

(52) U.S. Cl. CPC E05B 17/2092; E05B 17/20

(57) ABSTRACT

An automatic locking mechanism includes a heavy hammer, a baffle, a shifting piece, and a rotary shaft. The shifting piece is fixed on a locking rod of a lockset. The baffle is rotatably mounted on the rotary shaft. An impact component is arranged at one end of the baffle, and a stopper is arranged at the other end of the baffle. The stopper is located between the shifting piece and a lock body of the lockset. The stopper is rotatable into and out of the moving trajectory of the shifting piece. The heavy hammer is slidably arranged on a slide rod parallel to the lock body. The impact component is rotatable into and out of the moving trajectory of the heavy hammer.

### FIELD

The present invention belongs to the technical field of locksets, and more particularly to an automatic locking mechanism for preventing a lockset from being opened under impact.

### BACKGROUND

An existing lockset is locked in a manner in which a lock block (or a lock pin) stops a latch. In the process of opening the lockset, the lock block (or the lock pin) is moved to enable a locking rod to slide out of a movement passage of the latch to get rid of the obstruction to the latch and a handle is pulled to enable a door latch to move, thereby opening the lockset. Many existing locksets are vulnerable to impact to be opened. When an external force is applied onto the lockset in a direction in which the lock block (or the lock pin) is opened, the lock block (or the lock pin) moves in a direction in which the lockset is to be opened. When the applied external force is sufficient, the lock block (or the lock pin) moves instantaneously, and if the handle is pulled to enable the door latch to move downwards at the instant when the locking rod moves, the lockset is probably opened.

Although locking mechanisms are mounted on many existing locksets, many locking mechanisms are arranged in movement passages of locking rods when locksets are locked to prevent slide of the locking rods. When a lockset is opened normally, a locking mechanism needs to be opened first to release locking of a locking rod, so as to perform an unlocking action, which causes great inconvenience to a user of the lockset such that user experience is relatively poor. Meanwhile, an existing locking mechanism cannot effectively prevent a lockset from being opened under impact, and in many cases, a locking mechanism slides with a locking rod, which neutralizes an effective locking effect.

### SUMMARY

In view of deficiency in the prior art, the present invention provides an automatic locking mechanism for preventing opening under impact, to prevent a lockset from being opened under impact.

For the purpose of achieving the foregoing objective, a technical solution adopted in the present invention is: providing an automatic locking mechanism, for preventing a lockset from being opened under impact, the lockset including a locking rod and a lock body, and the locking rod being arranged at an end of the lock body. The automatic locking mechanism includes a heavy hammer, a baffle, a shifting piece, and a rotary shaft, the shifting piece being fixed on the locking rod, the baffle being rotatably mounted on the rotary shaft, the heavy hammer being connected to one end of the baffle, a stopper being arranged at the other end of the baffle, the stopper being located between the shifting piece and the lock body, and the stopper being rotatable into and out of the moving trajectory of the shifting piece.

Preferably, a reset component is further included, the reset component being used to reset the heavy hammer or the baffle.

Preferably, the reset component is a torsion spring or a compression spring.

Preferably, the lockset further includes a lockset compression spring, the lockset compression spring being mounted between the shifting piece and the lock body.

Preferably, a distance between the heavy hammer and the rotary shaft is less than a distance between the stopper and the rotary shaft.

The present invention further provides an automatic locking mechanism, for preventing a lockset from being opened under impact, the lockset including a locking rod and a lock body, and the locking rod being arranged at an end of the lock body. The automatic locking mechanism includes a heavy hammer, a baffle, a shifting piece, and a rotary shaft, the shifting piece being fixed on the locking rod, the baffle being rotatably mounted on the rotary shaft, an impact component being arranged at one end of the baffle, a stopper being arranged at the other end of the baffle, the stopper being located between the shifting piece and the lock body, the stopper being rotatable into and out of the moving trajectory of the shifting piece, the heavy hammer being slidably arranged on an outer side of the lock body and on a slide rod parallel to the lock body, and the impact component being rotatable into and out of the moving trajectory of the heavy hammer.

Preferably, the impact component is a bump, and a distance between the bump and the rotary shaft is less than a distance between the stopper and the rotary shaft.

Preferably, a reset component is further included, the reset component being used to reset the heavy hammer or the baffle.

Preferably, the lockset further includes a lockset compression spring, the lockset compression spring being mounted between the shifting piece and the lock body.

Preferably, the impact component is a baffle trigger, a crank is arranged at a top end of the baffle trigger, and a distance between the crank and the rotary shaft is less than a distance between the stopper and the rotary shaft.

Beneficial effects of the present invention are as follows:

For the automatic locking mechanism according to the present invention, when a lockset is under impact, a baffle rotates under the effect of a heavy hammer, thereby preventing movement of a locking rod. It is ensured that a stopper portion of the baffle can stop a shifting piece within a minimum time. Therefore, safety performance of the lockset is greatly improved. The automatic locking mechanism for preventing opening under impact according to the present invention has a simple structure and a small volume, can be arranged inside or outside a lockset, and is not easy to discover, which achieves relatively high concealment performance and safety performance.

### BRIEF DESCRIPTION OF THE DRAWINGS

FIG. 1 is a schematic structural view of an automatic locking mechanism in a normal state according to Embodiment 1.

FIG. 2 is a schematic structural view of the automatic locking mechanism under impact according to Embodiment 1.

FIG. 3 is a schematic structural perspective view of an automatic locking mechanism in a normal state according to Embodiment 2.

FIG. 4 is a schematic structural view of the automatic locking mechanism in the normal state according to Embodiment 2.

FIG. 5 is a schematic structural view of the automatic locking mechanism under impact according to Embodiment 2.

FIG. 6 is a schematic structural view of an automatic locking mechanism in a normal state according to Embodiment 3.

FIG. 7 is a schematic structural view of the automatic locking mechanism under impact according to Embodiment 3.

### DETAILED DESCRIPTION

In order to make the objectives and technical solutions of the embodiments of the present invention clearer, the technical solutions of the embodiments of the present invention are clearly and completely described below with reference to the accompanying drawings of the embodiments of the present invention. It is obvious that the described embodiments are merely a part rather than all of the embodiments of the present invention. Based on the described embodiments of the present invention, all other embodiments obtained by persons of ordinary skill in the art without making creative efforts shall fall within the protection scope of the present invention.

One of ordinary skill in the art can understand that unless otherwise defined, all terms (including technical and scientific terms) used herein have the same meaning as commonly understood by one of ordinary skill in the art to which this invention belongs.

It should be further understood that, terms, such as those defined in commonly used dictionaries, should be understood as having a meaning consistent with their meaning in the context of the prior art, and will not be interpreted in an idealized or overly formal sense unless expressly so defined herein.

The term “and/or” in the present invention means that either or both elements may be present.

The terms “inner” and “outer” in the present invention respectively refer to, relative to the device itself, the direction toward the interior of the device and the opposite direction.

The term “connection” in the present invention may refer to direct connection between components or indirection connection between components by means of other components.

### Embodiment 1

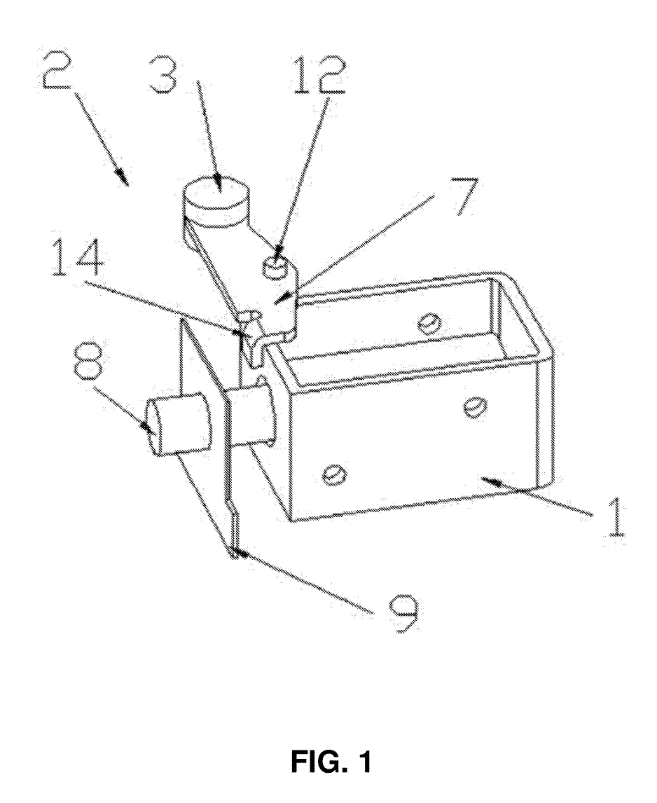

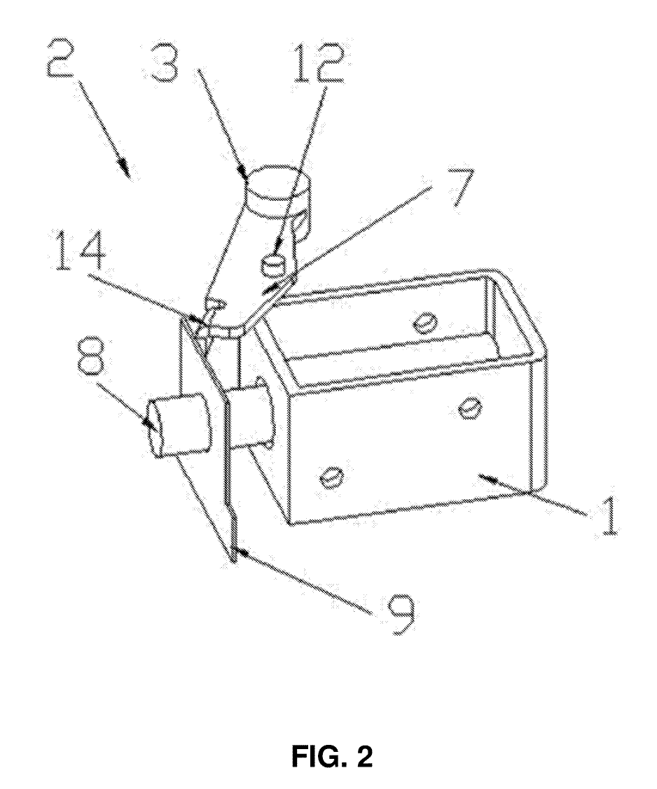

FIG. 1 and FIG. 2 show an automatic locking mechanism of the present invention, for preventing a lockset from being opened under impact. The lockset includes a locking rod 8 and a lock body 1. The locking rod 8 is arranged at an end of the lock body 1. The automatic locking mechanism includes a heavy hammer 3, a baffle 7, a shifting piece 9, and a rotary shaft 12. The shifting piece 9 is fixed on the locking rod 8. The baffle 7 is rotatably mounted on the rotary shaft 12. The heavy hammer 3 is connected to one end of the baffle 7, and a stopper 14 is arranged at the other end of the baffle 7. The stopper 14 is located between the shifting piece 9 and the lock body 1. The stopper 14 is rotatable into and out of the moving trajectory of the shifting piece 9.

A reset component is further included. The reset component is used to reset the heavy hammer or the baffle. The reset component is a torsion spring or a compression spring.

The lockset further includes a lockset compression spring 10. The lockset compression spring 10 is mounted between the shifting piece 9 and the lock body 1. The baffle 7 prevents movement of the locking rod 8 by stopping the shifting piece 9.

A distance between the heavy hammer 3 and the rotary shaft 12 is less than a distance between the stopper 9 and the rotary shaft 12.

A work group principle of the present invention is:

As shown in FIG. 1, in a locked state, the locking rod 8 stops a door latch. When the lockset is opened, the locking rod 8 retracts, and the door latch can move downwards to open the door. An existing lockset 1 does not have a locking mechanism 2. When the lockset 1 is under impact in an axial direction of the locking rod, the locking rod 8 moves to the right. In this case, if the handle is pulled to enable the door latch to move downward, the lockset may be opened.

As shown in FIG. 2, in a case in which the locking mechanism 2 is added, when the lockset 1 is under impact in the axial direction of the locking rod, at the same time when the locking rod 8 moves to the right, the heavy hammer 3 also moves to the right, the heavy hammer 3 actuates the baffle 7 to rotate about the rotary shaft 12, and the baffle 7 can be reset depending on a reset component 6 in any form without interfering with normal working of the lockset.

### Embodiment 2

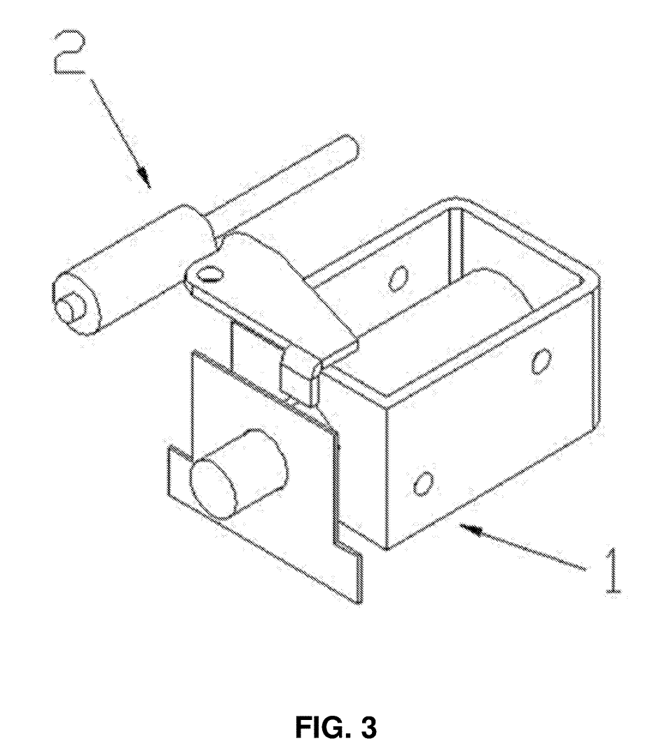

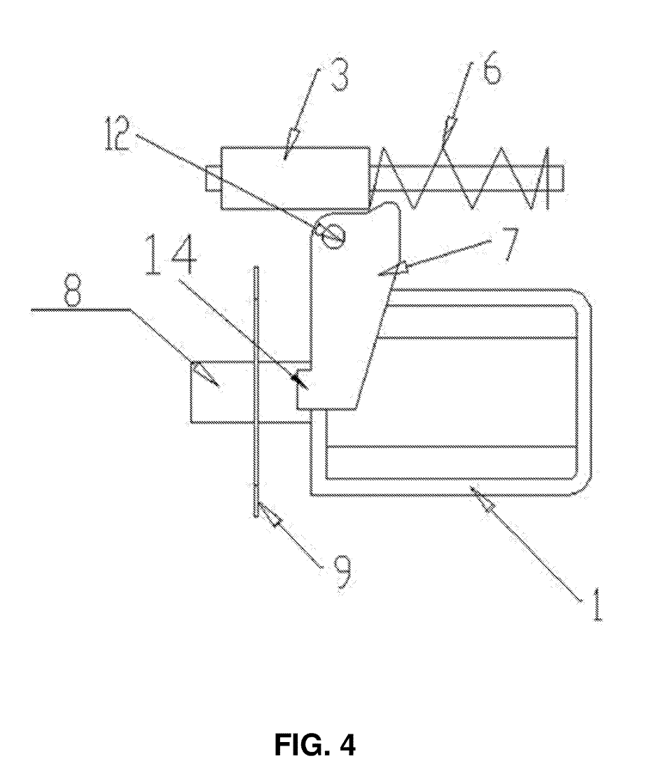

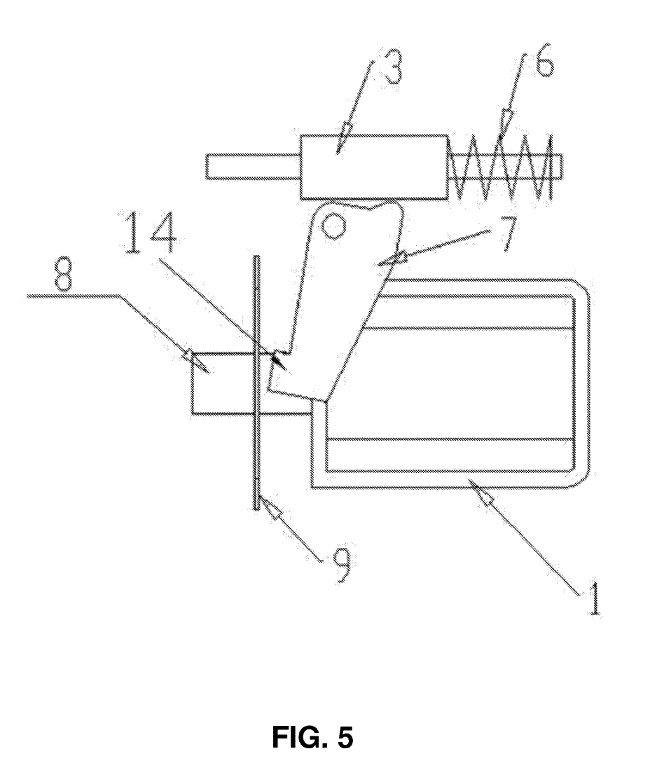

FIG. 3 to FIG. 5 show an automatic locking mechanism of the present invention, for preventing a lockset from being opened under impact. The lockset includes a locking rod 8 and a lock body 1. The locking rod 8 is arranged at an end of the lock body 1. The automatic locking mechanism includes a heavy hammer 3, a baffle 7, a shifting piece 9, and a rotary shaft 12. The shifting piece 9 is fixed on the locking rod 8. The baffle 7 is rotatably mounted on the rotary shaft 12. A bump is arranged at one end of the baffle 7, and a stopper 14 is arranged at the other end of the baffle 7. The stopper 14 is located between the shifting piece 9 and the lock body 1. The stopper 14 is rotatable into and out of the moving trajectory of the shifting piece 9. The heavy hammer 3 is slidably arranged on a slide rod 8 parallel to the lock body 1. An impact component is rotatable into and out of the moving trajectory of the heavy hammer. A distance between the bump and the rotary shaft 12 is less than a distance between the stopper and the rotary shaft. A reset component is further included. The reset component is used to reset the heavy hammer 3 or the baffle 7. The lockset further includes a lockset compression spring. The lockset compression spring is mounted between the shifting piece and the lock body.

The bump is in contact with the heavy hammer 3. When moving under impact, the heavy hammer 3 impacts on the bump in the sliding moving trajectory of the heavy hammer 3. The bump rotates under the impact of the heavy hammer 3, to actuate the baffle 7 to rotate about the rotary shaft 12. The stopper portion 14 is arranged at the other end of the baffle 7. The stopper portion 14 is not in the moving trajectory of the shifting piece 9 in a non-impact state. That is, during normal working of the lockset, the shifting piece 9 is not affected by the stopper 14. The heavy hammer 3 is located on an outer side of the rotary shaft 12.

The weights of the heavy hammer 3 and the locking rod 8 need to have equal proportions to two spring forces. That is, a ratio of the weight of the heavy hammer 3 to the pressure of the lockset compression spring 10 is equal to a ratio of the weight of the locking rod 8 to the pressure of a reset component 6, so as to ensure that under impact, the heavy hammer 3 can move along with the locking rod 8.

During movement, the heavy hammer 3 needs to come in contact with the bump of the baffle 7 within a minimum time. The bump of the baffle 7 is relatively close to the rotary shaft 12, and the stopper portion 14 is relatively far away from the rotary shaft 12. The linear speed of the movement of the stopper portion 14 of the baffle 7 needs to be several times as large as that of the movement of the bump, to ensure that the stopper portion 14 of the baffle 7 can stop the shifting piece 9 within a minimum time.

A locking mechanism 2 is an independent component, and does not affect normal working of an original lockset 1.

### Embodiment 3

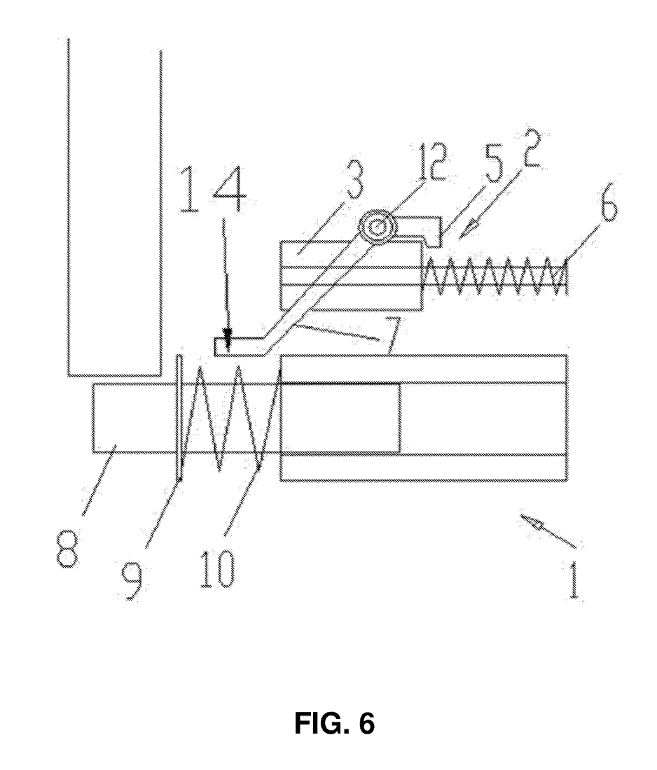

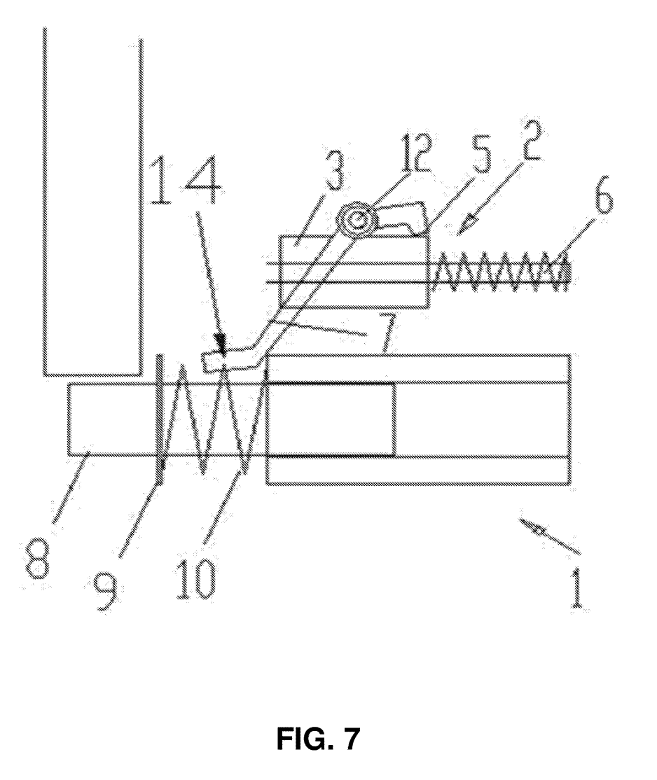

As shown in FIG. 6 and FIG. 7, the present embodiment is different from Embodiment 2 in that, a component, impacting on a heavy hammer 3, on a baffle 7 is a baffle trigger 5. A crank is arranged at a top end of the baffle trigger 5. A distance between the crank and a rotary shaft 12 is less than a distance between a stopper 14 and the rotary shaft 12. The crank is in contact with the heavy hammer 3. When moving under impact, the heavy hammer 3 impacts on the crank in the sliding moving trajectory of the heavy hammer 3. The crank rotates under the impact of the heavy hammer 3, to actuate the baffle 7 to rotate about the rotary shaft 12. The stopper 14 is arranged at the other end of the baffle 7. The stopper 14 is not in the moving trajectory of a shifting piece 9 in a non-impact state. That is, during normal working of a lockset, the shifting piece 9 is not affected by the stopper 14. The heavy hammer 3 is located on an outer side of the rotary shaft 12.

During movement, the heavy hammer 3 needs to come in contact with the crank of the baffle 7 within a minimum time. The crank of the baffle 7 is relatively close to the rotary shaft 12, and the stopper 14 is relatively far away from the rotary shaft 12. The linear speed of the movement of the stopper portion 14 of the baffle 7 needs to be several times as large as that of the movement of the crank, to ensure that the stopper portion 14 of the baffle 7 can stop the shifting piece 9 within a minimum time.

The baffle trigger 5 and the baffle 7 are integrated. The crank is in contact with the heavy hammer 3. When moving under impact, the heavy hammer 3 impacts on the crank in the sliding moving trajectory of the heavy hammer 3. The crank rotates under the impact of the heavy hammer 3, to actuate the baffle 7 to rotate about the rotary shaft 12.

The stopper 14 is arranged at the other end of the baffle 7. The stopper 14 is not in the moving trajectory of a shifting piece 9 in a non-impact state. That is, during normal working of a lockset, the shifting piece 9 is not affected by the stopper 14. The heavy hammer 3 is located on an outer side of the rotary shaft 12.

The implementations of the present invention are specifically described in detail above, but they are not to be construed as limiting the scope of the present invention. It should be noted that several modifications and improvements can be made by one of ordinary skill in the art without departing from the concept of the present invention. All these modifications and improvements are within the protection scope of the present invention.

1. An automatic locking mechanism, for preventing a lockset from being opened under impact, the lockset comprising a locking rod and a lock body, and the locking rod being arranged at an end of the lock body, wherein the automatic locking mechanism comprises a heavy hammer, a baffle, a shifting piece, and a rotary shaft, the shifting piece being fixed on the locking rod, the baffle being rotatably mounted on the rotary shaft, the heavy hammer being connected to one end of the baffle, a stopper being arranged at the other end of the baffle, the stopper being located between the shifting piece and the lock body, and the stopper being rotatable into and out of the moving trajectory of the shifting piece.

2. The automatic locking mechanism according to claim 1, further comprising a reset component, the reset component being used to reset the heavy hammer or the baffle.

3. The automatic locking mechanism according to claim 2, wherein the reset component is a torsion spring or a compression spring.

4. The automatic locking mechanism according to claim 2, wherein the lockset further comprises a lockset compression spring, the lockset compression spring being mounted between the shifting piece and the lock body.

5. The automatic locking mechanism according to claim 1, wherein a distance between the heavy hammer and the rotary shaft is less than a distance between the stopper and the rotary shaft.

6. An automatic locking mechanism, for preventing a lockset from being opened under impact, the lockset comprising a locking rod and a lock body, and the locking rod being arranged at an end of the lock body, wherein the automatic locking mechanism comprises a heavy hammer, a baffle, a shifting piece, and a rotary shaft, the shifting piece being fixed on the locking rod, the baffle being rotatably mounted on the rotary shaft, an impact component being arranged at one end of the baffle, a stopper being arranged at the other end of the baffle, the stopper being located between the shifting piece and the lock body, the stopper being rotatable into and out of the moving trajectory of the shifting piece, the heavy hammer being slidably arranged on a slide rod parallel to the lock body, and the impact component being rotatable into and out of the moving trajectory of the heavy hammer.

7. The automatic locking mechanism according to claim 6, wherein the impact component is a bump, and a distance between the bump and the rotary shaft is less than a distance between the stopper and the rotary shaft.

8. The automatic locking mechanism according to claim 6, further comprising a reset component, the reset component being used to reset the heavy hammer or the baffle.

9. The automatic locking mechanism according to claim 8, wherein the lockset further comprises a lockset compression spring, the lockset compression spring being mounted between the shifting piece and the lock body.

10. The automatic locking mechanism according to claim 6, wherein the impact component is a baffle trigger, a crank is arranged at a top end of the baffle trigger, and a distance between the crank and the rotary shaft is less than a distance between the stopper and the rotary shaft.

11. The automatic locking mechanism according to claim 2, wherein a distance between the heavy hammer and the rotary shaft is less than a distance between the stopper and the rotary shaft.

12. The automatic locking mechanism according to claim 3, wherein a distance between the heavy hammer and the rotary shaft is less than a distance between the stopper and the rotary shaft.

13. The automatic locking mechanism according to claim 7, further comprising a reset component, the reset component being used to reset the heavy hammer or the baffle.
